(19) United States
(12) Patent Application Publication
(10) Pub. No.: US 2015/0029826 A1
(43) Pub. Date: Jan. 29, 2015

(54) Obscured Message Display for Watches

(71) Applicant: Walter Gerard Antognini, New York, NY (US)

(72) Inventor: Walter Gerard Antognini, New York, NY (US)

(21) Appl. No.: 14/210,475

(22) Filed: Jul. 28, 2014

Related U.S. Application Data
(60) Provisional application No. 61/790,361, filed on Mar. 15, 2013.

(51) Int. Cl. G04G 9/00; G04G 21/04

(52) U.S. Cl. CPC G04G 9/0064; G04G 21/04
USPC 368/10

(57) ABSTRACT

A system for communicating between one digital device and another digital device, such a watch, is disclosed. The user of the system is provided a number of manners in which messages from the first device are to be received, at least some of which are obvious only to the user, hiding the content of such messages from other persons near the intended recipient.

### BACKGROUND OF THE INVENTION

The invention relates generally to communications between digital devices and more particularly between a smartphone and a digital watch, although it should be understood that the invention is not limited so.

Smartphones are capable of receiving a variety of communications, including voice calls, text messages and various communications made possible by reception of the Internet. A smartphone user therefore has at his or her disposal the ability to receive a wealth of information almost regardless of location. But while these communications are theoretically available, social or other circumstances may limit one's inclination to view these communications. For example, frequently accessing and then viewing one's phone while at dinner with family, friends or clients may prove awkward and produce undesirable results. Even absent these potentially awkward social conditions, there may be circumstance when the user does have phone in hand or even nearby but would naturally be wearing a watch. What is needed then is a way to convey needed or desired information to a watch where that information can be presented to the user in a way or ways selected by the user as being appropriate under the circumstances where those circumstances could vary from one situation to another.

It is an objective of the invention to allow a user to have digital communications sent from a smartphone to a digital watch in one or more manners chosen by the user. With at least some of these options, the fact that information is even being conveyed, much less the content of that information, is known only to the user. While most of these options require the user to at least glance at his her watch, at least option conveys information without even the need to glance at the watch. In this manner the user can choose which method of information conveyance best suits the circumstances.

It is a further objective of the invention to allow the user to not only receive information without others noticing but to also send information without others noticing. The manner in which this is done would presumably be limited, perhaps significantly so, by the capabilities of the digital watch. But, even if limited, the ability to convey information or other signals without others knowing can be a great benefit.

These and other objectives will become apparent in the following description.

### SUMMARY OF THE INVENTION

The preferred embodiment involves a system of communication between a smartphone and a digital watch. The preferred embodiment is described by reference to an Android smartphone and a Pebble™ watch. Both of these digital devices are capable of being programmed. The Pebble watch is further capable of receiving messages from other digital devices including an Android smartphone and then displaying those messages. The watch can display on its watch face and is also capable of sending signals through a vibration of the watch. These capabilities gives rise to the system further described.

Smartphones are capable of receiving a variety of information from outside sources in an variety of manners. The system contemplates an application on the smartphone as well as an application on the watch where these applications will communicate with each other. In using the smartphone application, the user can establish that certain messages (e.g., dependent on the source or the person sending the message) will be received by the watch and displayed in one way while other messages will be received by the watch and displayed in another way. The system will also provide default setting in those instance where the user has not made a choice.

The primary possibilities on how the watch can display messages are: 1) textual display of a normal nature on the watch face, 2) a non-obvious display on the watch face—this possibility could involve, for example, minor alterations to the watch face which to nearby persons would appear to be just a watch face but to the user would carry special meaning, 3) similar to the above, the watch face could contain minor alterations that through existing codes, such as Morse Code, could convey information and would appear as just a watch face to nearby persons but to the user would provide an associated message, 4) vibrations of the watch which could be quick and simple or more complex such as using vibrations to send messages by using Morse Code, and, 5) audible alerts which again could be relatively quick and simple or more complex.

In the preferred embodiment described, a Pebble™ watch and an Android™ smartphone are used. Persons skilled in the art are referred to the Pebble website, www.getpebble.com, and its referenced SDK. These persons are similarly referred to SDKs and associated documentation for Android phones. Together with other known resources, one skilled in the art can recreate the functions described herein (see, however, the Pebble site regarding audio alerts).

While the watches currently existing typically allow for only minor input into the watch, these inputs could be used to send a signal to the watch, such as a signal to replace a text display with a normal clock, or to communicate to the smartphone, such as a request to seek the score of a sporting event and send that on to the watch.

The invention discloses further uses. One involves displaying geographic directional information, where again, this information could be obvious to all who see the watch or obvious only to the person wearing the watch. Another involves security or other emergency alerts. While a further use involves alerts more commercial in nature. And the description describes other embodiments in which the system provides alerts to devices other than watches, such as to televisions.

### BRIEF DESCRIPTIONS OF THE DRAWINGS

FIG. 1 illustrates one possible watchface produced by the invention where that watchface displays a digital readout of the time along with a modified Morse Code display of a message.

FIG. 2 illustrates a second possible watchface produced by the invention where that watchface displays an analog display of the time along with the display of a message using a unique code of the invention.

FIG. 3 illustrates a third possible watchface produced by the invention where that watchface displays an analog display of the time along with the display of a message using a modified Morse Code.

### DETAILED DESCRIPTIONS OF THE PREFERRED EMBODIMENTS

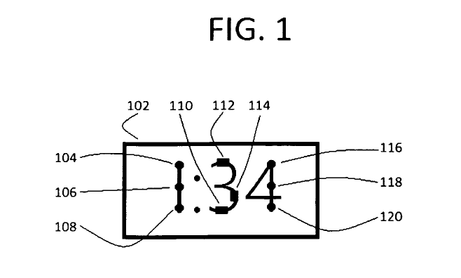

FIG. 1 illustrates one possible display produced by the invention intended to be understood by the wearer of the watch but not by those persons near the wearer. Display 102 represents the overall appearance of the watchface, indicating a time of 1:34. The number one contains 3 dots, dots 104, 106 and 108. These 3 dots together are intended to represent the letter “S”, as in accordance with Morse Code. The number 3 contains 3 dashes, dashes 110, 112 and 114. These 3 dashes together are intended to represent the letter “O”, as in accordance with Morse Code. The number 4 contains three dots, dots 116, 118 and 120. These three dots together are intended to represent the letter “S”, as in accordance with Morse Code. Together then, these dots and dashes indicate the message, “S O S”.

It should be noted that the display suggested by FIG. 1 is generally not the preferred manner in which the invention would convey a message to the wearer, although the invention would allow the wearer to use such display. The display of FIG. 1 presents certain issues. First, the amount of information that can be sent is fairly limited. Second, there is small visual distinction between the dots and dashes, as illustrated in FIG. 1. Third, the types of messages that can be sent would presumably be limited—for example, it would be typically be difficult to send such analog data as sports scores. Nonetheless, there may be instances in which the wearer would want to use a display such as that in FIG. 1, such as when the wearer desires to receive a brief alert.

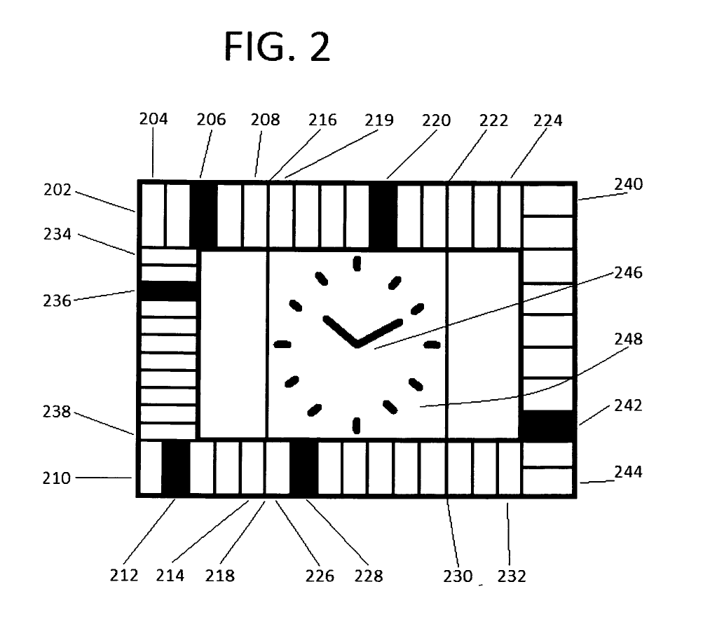

FIG. 2 illustrates a second possible display produced by the invention intended to be understood by the wearer of the watch but not by persons near the wearer. This display 202 represents the overall appearance of the watchface. This display consists of a number of components. The overall intent of this display is twofold. First, the display shows the present time of approximately 10:09. Second, the display provides updated information of a football game for which the wearer has previously requested updates. More particularly, the information conveyed indicates that the away team is winning 35-22, 80% of the way through the fourth quarter. The display conveys this information using its own code. On the top, the display contains a series of 5 boxes, starting at box 204 and ending at box 208. These boxes are intended to show in the present context the left digit of the score of the away team, following the normal protocol of displaying the away team score prior to that of the home team. In the current context and display, the third such box, box 206, is darkened, indicating that the left digit is 3. Note that if the score was in single digits, none of the five boxes would be darkened. The top also contains 10 more boxes, starting at box 219, ending at box 224. These boxes are intended to convey the right digit of the score. In the current context and display, the fifth such box, box 220, is darkened, indicating that the right digit of the score is a 5. Hence, the away team has 35 points. In a like fashion, the five boxes starting at box 210, ending at box 214 are intended to show the left digit of the home team's score while the 10 boxes starting at box 226 and ending at box 232 indicate the right digit of the home team's score. Because the second such box, box 212 and the second such box, box 228, are darkened, the display indicates that the home team has a score of 22. Darkened lines 214 and 216 of the display are intended as visual cues to the wearer showing separation between the 5 top boxes starting at box 204 and ending at box 208 and the bottom five boxes, starting at box 210 and ending at box 214, from the top ten boxes, starting at box 218 and ending at box 224 and the bottom 10 boxes, starting at box 226 and ending at box 232. Darkened lines 222 and 230 are not intended to convey any information. Instead, they are present in the display to provide symmetry with darkened lines 216 and 218 so as to minimize any unusual appearance of the watchface. Display 202's left side contains 11 boxes, boxes starting at box 234 and ending at box 238. These boxes are intended to display the last quarter, period, inning, etc. of the game that has fully elapsed. Because the third such box, box 236, is darkened, three quarters have fully elapsed, indicating that the game is in the fourth quarter (or the game is in between the third and fourth quarter). Display 202's right side contains 10 boxes, boxes starting at box 240 and ending at box 244. These boxes are intended to display the proportion of the current quarter, period, inning, etc., that has elapsed. Because the eighth such box, box 242 is darkened, 80% of the current quarter has elapsed. Hence, the game is in the fourth quarter with 80-90% of the time in the fourth elapsed. Finally, display 202 provides an analog display 246 of the current time, approximately 10:09. This analog display includes 12 marks, one for each hour, to assist the wearer in determining the current time. One such mark, mark 248, represents 4 o'clock in the case of the hour hand, 20 minutes past the hour in the case of the minute hand.

Naturally, the invention allows for variations of this display. For example, in the context of games such as basketball, a question naturally arises as to how to display a score higher than 59. This could also become an issue in football games and other sporting events, although presumably not for hockey or baseball. One manner in which to address this issue is that each of the 5 boxes starting at box 204 and ending at box 208 and the 5 boxes starting at box 210 and ending at box 214, could be split into 2 boxes, allowing a score of up to 109. A further adjustment could be made, such as removing line 216 and/or line 218 (depending on the score) to indicate that 100 points has been scored and that the score otherwise indicated is in addition to the 100 points scored. Other embodiments might make other adjustments depending on the sport being followed. For example, in the context of a hockey game, there might be 5 boxes indicating the period that has elapsed—one for each of the 3 regular periods, one for the overtime period and one for the shootout (this box might be darkened, for example, to indicate that the game is over and that it ended in a shootout). The invention makes all such embodiments available to be chosen by one skilled in the art.

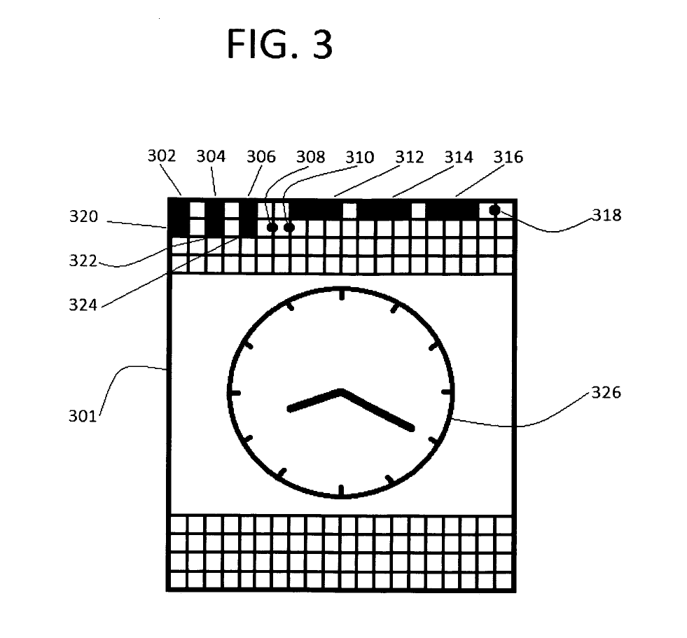

FIG. 3 illustrates a third possible display produced by the invention intended to be understood by the wearer of the watch but not by persons near the wearer. This display 301 represents the overall appearance of the watchface. This displays consists of a number of components. The overall intent of this display is twofold. First, the display shows the present time of approximately 8:22, as shown in analog display of the time, display component 326. Second, the display presents a message transmitted through an associated smartphone. In addition to display component 326 showing the time, display 301 contains three rows of boxes on top of display component 326 and three rows of boxes underneath display component 326. A total of 120 such boxes are present in display 301. These boxes are intended to be used to communicate a message from the smartphone to the watch. For purposes of this description, a modified version of Morse Code will be used. While the description will assume that letters and numbers will follow the conventions of Morse Code, the spaces in between letters or to represent the end of the message are not followed as those conventions are considered to use an excessive amount of spaces for the purposes intended here. Of course, in other embodiments, the full protocols of Morse Code could be used. With these considerations in mind, the 120 boxes are used to send the equivalent of the dots and dashes and spaces used in Morse Code. Of course, those 120 boxes could be used to send messages according to some other code.

The boxes are used in the present illustration to send the message, “S O S”. Boxes 302, 304 and 306 are darkened. Single undarkened boxes are in between these boxes. Accordingly to the present embodiment, the boxes 302, 304 and 306 represent three dots which in Morse Code represents an “S”. Two undarkened boxes follow until the next series of darkened boxes, 312. In this current embodiment, these two consecutive undarkened boxes represent a space between letters, a departure from the formal protocol of Morse Code. Series of boxes 312, 314 and 316, a total of three consecutive boxes, represents a dash in the current embodiment. Thus, one darkened box represents a dot while three consecutive darkened boxes represents a dash. Taken together, series of boxes 312, 314, and 316 represent 3 dashes which in Morse Code represents the letter “O”. These darkened boxes are followed by a small circle, circle 318. Circle 318 signals to the wearer a line break—i.e., move to the next line for further parts of the message. Dots 320, 322 and 324 represent another letter, which in accord with Morse Code would be another “S”. Circles 308 and 310, two consecutive circles, are used in the present embodiment to signal to the user an end of the message. One might notice from this FIG. 3 that most of the boxes are left blank due to the shortness of the message. In other embodiments, many of these remaining boxes are randomly darkened so as to present a relatively uniform visual appearance primarily for persons other than the wearer. In this way, the message could be even more inconspicuous. It should be noted that because the two circles 308 and 310 signaled the end of the message, the wearer would know to ignore any boxes following these two circles.

While 120 boxes provides the ability to communicate a message greater than a few letters, the capacity is still fairly limited. Using abbreviation such as is common practice in texting could improve the communication capacity. Likewise, further modifications to Morse Code could improve the capacity—e.g., using two consecutive boxes to represent a dash and to eliminate some symbols that might be sent by Morse Code. Indeed, an entirely new code could be developed in order to more efficiently send messages.

The present invention provides possible uses beyond those described above, including but not limited to the following:

The watch can be used to send scores of games through vibrations. This might be especially useful for low scoring games such as hockey and baseball. For example, a wearer interested in the San Francisco Giants game could request scoring updates such that a first vibration would signal an incoming score through vibrations, followed by a pause (e.g., two seconds), followed by a number of vibrations equal to the score for the away team (or a long vibration or some other unique signal if that score is zero), followed by a pause, followed by a number of vibrations equal to the score of the home team, followed by a pause, followed a number of vibrations equal to the number of innings that have elapsed. As this method might require the wearer to pay close attention and some part of the message may not be correctly understood (or forgotten) by the wearer, the invention allows for another feature. If the user wants to see the score on the display, the wearer could use the motion detection feature of the watch such that by shaking the watch, a signal would be sent back to the smartphone to send the score to the display (whether in text or through some less obvious manner as illustrated by reference to the Figures). And then, the wearer could again shake the watch to “erase” that display—e.g., return the display to its state prior to the display being changed.

As another preferred aspect of the invention, the user's search requests (i.e., the messages that the user desires to have communicated) will be captured and transmitted to a central source, such as the server of the enterprise creating the application to be loaded on the devices. This data, perhaps in combination with other data, can be used, inter alia, for purposes of providing advertising to the user of greatest interest to the user.

The watch could be used as a geographical locator. There are circumstances where a person needing to know how to get to a location may not want others to know of such need. Or, using a GPS unit or even a phone capable of receiving geographic location information and data on getting to a location may prove cumbersome. The watch could be used to assist in this purpose. And, the watch could send cues to the wearer that are not obvious to others nearby. These cues could be generated by the smartphone as a result of the wearer instructing an application on the smartphone to send these signals to the watch based on location information received by the phone. One embodiment of how the invention could provide these cues is made by reference to FIG. 2. The analog display could contain a special mark, perhaps smaller than small hand indicating the hour. This special mark could appear on the circle on the periphery of the time readout. For example, FIG. 2 has small marks on this periphery indicating the hour—12 small marks, one for each hour. Mark 248 is one of those 12 marks. The additional special mark could reside on or just outside of these small marks. Because this special mark could be anywhere in a 360 degree range, this mark could signal to the wearer the direction that should be followed relative to the current location. This signal would be sent to the watch from the user's smartphone. In those embodiments where the watch itself is capable of receiving geographic location data (such as a watch equipped capable of receiving GPS signals), the signals would not need to be transmitted to the phone. The squares surrounding the analog component of the display could be used for such purposes as indicating the distance remaining to the desired location.

Perhaps in combination with the prior aspect that allows capturing of user requested data, the directional capability of the watch could be used to indicate nearby locations not directly requested by the user. For example, if the user wants to find the nearest gas station, but does not know the location, the application on the smartphone could allow the user to ask for direction to the nearest gas station and the phone could combine this request with location information to provide directional cues to be sent to the watch. As another variation, advertising could be sent through the phone to the watch based on current location.

The description to this point has placed on emphasis on digital means to send messages to the wearer such that only the wearer knows of the content of such message. This same goal can be achieved through physical means. The watch screen could have on its face a medium which makes the display readable only to those looking directly at the screen. Such means could be part of the manufacture of the watch or a medium could be applied to the watchface after manufacture, including by the wearer him or herself. The use of screen coverings to hide computer screens from onlookers is well-known, and these same techniques could be applied in the present context. And of course, these physical means could be combined with the digital means described herein.

While the above description has primarily focused on communications from the smartphone to the watch, communications could also be sent to the smartphone from the watch. Naturally, the nature and means of communications would have to be limited based on the ability of the watch to allow input. But certainly, some signals, perhaps in addition to actual text instructions, can be generated by the wearer and sent to the smartphone. For example, if the smartphone has sent a message indicating that a particular sports team is winning a game, the watch could send back a signal, e.g., by shaking the watch, thereby creating a signal based on the watch's accelerometer, asking for more details as might be then displayed as text on the watch (i.e., not obscured from view by others). A further shake might then erase this display and return the display to its former state. Under more unusual circumstances, the wearer may want to take advantage of the watch's typically limited input capabilities to send more elaborate signals such as text messages, or perhaps an email address or URL for a recipient of a picture taken by the watch's camera. In the context of watch camera, another manner of the watch generating a signal is by the watch taking a picture of a machine-readable code or other machine-recognizable mark or feature whereby a particular meaning could be extracted from that picture as might be the case with a barcode including, perhaps, a two-dimensional barcode. This information could be sufficiently complex that a new request could be made to the smartphone application. For example, if the wearer passes an advertisement for a restaurant chain, a barcode on that advertisement could be provided such that by the watch's camera capturing that barcode, the smartphone would be instructed to send directional information to the watch for the nearest such restaurant.

The invention can provide sometimes crucial purposes by providing alerts to the wearer. These alerts could utilize many of the previously described manners of obscuring the alerts from onlookers. These alerts could include, for example, a price alert. If a stock price has dropped or risen to a certain preprogrammed level, the smartphone could send that signal to the watch, including in a fashion that is obscured to outsiders. One such possibility would cause the watchface to switch from one display that may not be best suited for such messages to another that is. Another such possibility, as might be the case of a simple alert, involves just the mere change of a watchface display. For example, if the wearer wanted to be alerted if his or her sports team's won a game, the mere change from one watchface to another could be that signal and the content of the new display could be irrelevant to this signal. Alternatively, the switch of the display from the first display to a yet further display (i.e., a third possible display) could provide a signal that that sports team lost the game. Of course, the new watchface display could also provide additional information, such as the actual score of the game.

In the context of alerts, alerts could be based on geographic information. For example, if the wearer wanted to be alerted to traffic jams, an alert could be sent based on the wearer's current location that a traffic jam is near. The alert could be that of a widespread emergency such as a tornado warning in the area. The wearer might instruct the smartphone to always send out such alerts, not just on a specific request.

The alert could be that the phone has received an incoming message, perhaps from only a specified person or person (e.g., only members of the immediate family but not from co-workers or friends).

Consistent with a prior description, the wearer might then shake the watch so as to display more detail, such as the message itself.

While the description thus far has focused on communications involving a watch, these messages may naturally be sent to other capable digital devices such as televisions and computers.

What is claimed is:

1. A method of communication comprising:
obtaining access to information which can be expressed as text;
communicating at least some of that information to a human-wearable device capable of
receiving such at least some of that information;
converting that at least some of the information to data that can be displayed in a manner intended to be understood by the wearer of the device but not by others nearby;
displaying on the human-wearable device that data intended to be understood by the wearer of the device but not by others nearby.

2. The method of claim 1 where the display of data intended to be understood by the wearer of the device but not by others nearby comprises a visible display.

3. The method of claim 1 where the display of data intended to be understood by the wearer of the device but not by others nearby consists of at least in part an audio alert.

4. The method of claim 1 where the display of data intended to be understood by the wearer of the device but not by others nearby consists of at least in part of at least one vibration.

5. The method of claim 1 where the display is an alert based on geographic location.

6. The method of claim 1 where such at least some of the information comprises geographic data.

7. The method of claim 1 further comprising communicating digital information from the human-wearable device.

8. The method of claim 7 further comprising obtaining and communicating information back to the human-wearable device where that information communicated back is derived at least in part based on the information communicated from the human-wearable device.

9. A method of communication comprising:
obtaining access to information which can be expressed as text;
converting at least some of the information to data that can be displayed in a manner intended to be understood by the wearer of a device but not by others nearby;
communicating at least some of that data to a human-wearable device capable of receiving such data;
displaying on the human-wearable device that data intended to be understood by the wearer of the device but not by others nearby.

10. The method of claim 9 where the display of data intended to be understood by the wearer of the device but not by others nearby comprises a visible display.

11. The method of claim 9 where the display of data intended to be understood by the wearer of the device but not by others nearby consists of at least in part an audio alert.

12. The method of claim 9 where the display of data intended to be understood by the wearer of the device but not by others nearby consists of at least in part of at least one vibration.

13. The method of claim 9 where the display is an alert based on geographic location.

14. The method of claim 9 where such at least some of the information comprises geographic data.

15. A method of communication comprising:
sending a digital signal from a human-wearable device,
obtaining access to information which can be expressed as text following receipt of that digital signal sent from the human-wearable device;
communicating at least some of that information back to the human-wearable device;
converting that at least some of the information to data that can be displayed in a manner intended to be understood by the wearer of the device but not by others nearby;
displaying on the human-wearable device that data intended to be understood by the wearer of the device but not by others nearby.

16. The method of claim 15 where the display of data intended to be understood by the wearer of the device but not by others nearby comprises a visible display.

17. The method of claim 15 where the display of data intended to be understood by the wearer of the device but not by others nearby consists of at least in part an audio alert.

18. The method of claim 15 where the display of data intended to be understood by the wearer of the device but not by others nearby consists of at least in part of at least one vibration.

19. The method of claim 15 where the display is an alert based on geographic location.

20. The method of claim 15 where such at least some of the information comprises geographic data.
